(19) United States
(12) Patent Application Publication
(10) Pub. No.: US 2026/0329787 A1
(43) Pub. Date: Oct. 22, 2026

(54) PROGRAMMABLE GENERAL PURPOSE INPUT/OUTPUT CONTROL BLOCK

(71) Applicant: Synaptics Incorporated, San Jose, CA (US)

(72) Inventor: David Garrett, Tustin, CA (US)

(73) Assignee: Synaptics Incorporated, San Jose, CA (US)

(21) Appl. No.: 19/652,136

(22) Filed: Apr. 20, 2026

Related U.S. Application Data
(60) Provisional application No. 63/791,841, filed on Apr. 21, 2025.

(51) Int. Cl. G06F 13/20

(52) U.S. Cl. CPC G06F 13/20; G06F 2213/40

(57) ABSTRACT

Methods and apparatus for configuring input/output (IO) signals are disclosed. An example method is performed by an IO controller and includes receiving instructions for acting on one or more IO pins of a plurality of IO pins associated with the IO controller, identifying an IO group corresponding to the one or more IO pins, setting a state of one or more bits of at least one control register of a plurality of control registers based at least in part on the identified IO group, and performing a first action on the one or more IO pins based at least in part on the received instructions and the identified IO group.

### CROSS-REFERENCE TO RELATED APPLICATIONS

This application claims the benefit of U.S. Provisional Application No. 63/791,841, titled “PROGRAMMABLE GENERAL PURPOSE INPUT/OUTPUT CONTROL BLOCK” and filed on Apr. 21, 2025, which is incorporated by reference herein in its entirety.

### TECHNICAL FIELD

The present implementations relate generally to control systems for inputs and outputs to and from integrated circuits such as microcontrollers (MCUs) and microprocessors (MPUs), and more specifically to controlling general purpose input/output (GPIO) interfaces associated with such integrated circuits.

### BACKGROUND OF RELATED ART

Many integrated circuits, such as microcontrollers, microprocessors, and the like, include multiple inputs and outputs, such as multiple general purpose input/output (GPIO) pins. Such GPIOs may be used for a wide variety of applications and configurations, and as such, flexible and varied configurations are desirable. Such GPIOs may be used as inputs, outputs, as input enable or output enable signals, may be set for pull-up or pull-down configurations, and so on. Such configurability may aid in adapting to new peripherals, new standards, for adapting to timing issues, and so on.

Conventional controllers for GPIOs may require multiple instructions, or multiple clock cycles in order to apply a selected configuration to each of the GPIOs. For example, some controllers may use a read modify write protocol, where in order to apply a desired logic value to a given GPIO pin, the current value of that pin must be read first, and then the desired logic value may be applied.

### BRIEF DESCRIPTION OF THE DRAWINGS

The present implementations are illustrated by way of example and are not intended to be limited by the figures of the accompanying drawings.

FIG. 1 shows a block diagram of an example input/output (IO) control system within which the example techniques may be implemented.

FIG. 2 shows an example block diagram depicting one example of the IO registers and the GPIO interface of FIG. 1, in accordance with some implementations.

FIG. 3 shows an example block diagram depicting another example of the IO registers and the GPIO interface of FIG. 1, in accordance with some implementations.

FIG. 4 shows an example flow chart depicting an operation for configuring IO registers using IO groups, in accordance with some implementations.

FIG. 5 shows an example block diagram indicating a circuit for performing calculations on IOs using look-up tables, in accordance with some implementations.

FIG. 6 shows an illustrative flow chart depicting an example operation for configuring IO signals, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, techniques for controlling and configuring GPIOs may require a variety of reconfigurations, such as reconfiguring the GPIOs for receiving inputs, providing outputs, applying pull-up or pull-down resistors to GPIOs, configuring GPIOs as input enables or output enables, and so on. In addition, timing such reconfigurations may also be important, such as for not reading an input until a sufficient time has elapsed, such as for a signal to settle, and so on. Conventional techniques for reconfiguring GPIOs may require multiple clock cycles to apply all needed configurations, and may require external logic or additional clock cycles for tying such reconfigurations to specified timers. It would therefore be desirable to enable generalized reconfiguration of GPIOs to be performed more quickly, and for such reconfigurations to be applied with proper timing.

Various aspects relate generally to techniques for reconfiguring input/output (IO) pins coupled to an integrated circuit. More specifically, aspects of the present disclosure relate to dynamic reconfiguration of such IO pins, for example GPIO pins, using IO groups to apply such reconfigurations more quickly than with conventional techniques. Further aspects of the present disclosure relate to applying such dynamic reconfigurations with precise timing, by tying the reconfigurations to specified timers. For example, an IO controller may receive one or more instructions for acting on one or more IO pins of a plurality of IO pins associated with the IO controller, an IO group may be identified corresponding to the one or more IO pins, a state of one or more bits of each control register of a plurality of control registers may be set based at least in part on the identified IO group, and a first action may be performed on the one or more IO pins based at least in part on the received instructions and the identified IO group.

Particular implementations of the subject matter described in this disclosure can be implemented to realize one or more of the following potential advantages. Aspects of the present disclosure may allow for dynamic reconfiguration of IO pins, such as GPIO pins, associated with an integrated circuit more quickly and with fewer constraints as compared with conventional techniques. In some aspects, such reconfigurations may be performed in a single clock cycle rather than requiring multiple clock cycles to set the state of each control register separately. In some aspects, allowing such reconfiguration to be precisely timed based on one or more timers associated with the IO groups may enable precisely timed changes to the GPIO pins to be made more quickly as compared with conventional techniques. Keeping the address space small enough that all addresses in the address space may be included in a single instruction as part of a direct address may also provide for reconfiguration of GPIO pins to be performed more quickly than with conventional techniques. Still further, use of look-up tables coupled to the GPIOs may enable signals to be reordered, and for simple logic functions to be applied to inputs and outputs provided via the GPIO pins.

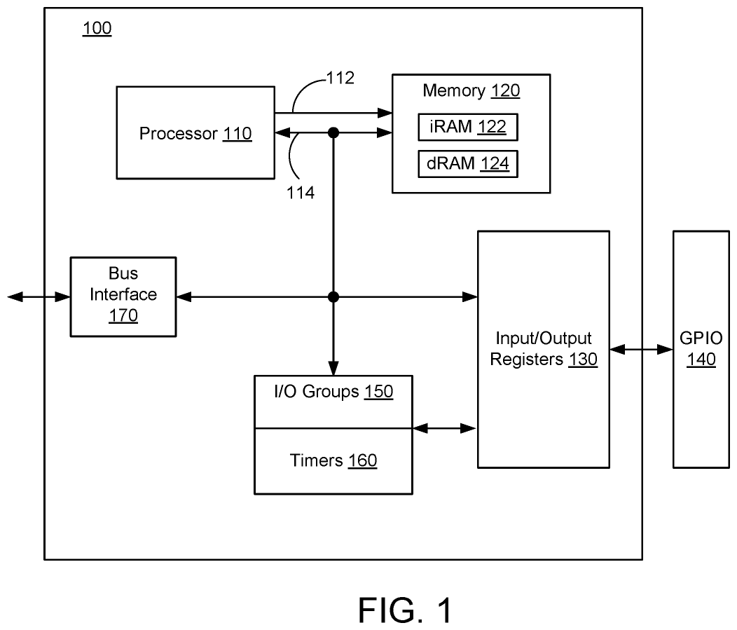

FIG. 1 shows a block diagram of an example input/output (IO) control system 100 within which the example techniques may be implemented. The IO control system 100 includes a processor 110, a memory 120, a plurality of IO registers 130, a GPIO interface 140, a plurality of IO group configuration registers 150, timers 160, and a bus interface 170. In some implementations, the IO control system 100 may be included in or coupled to a computing device, such as a system on chip. The IO control system 100 may be configured to control inputs and outputs for the computing device, which may be a device such as a cellular phone, a tablet computer, a laptop computer, television set top box, or another computing device.

The processor 110 may be a suitable microprocessor or microcontroller. For example, the processor 110 may operate using a reduced instruction set architecture, such as a Reduced Instruction Set Computer, or RISC, architecture. In some aspects, the processor 110 may be a 32-bit or 64-bit microprocessor or microcontroller. In some aspects, the processor 110 may operate in accordance with the RISC-V architecture.

The memory 120 may include a suitable non-transitory computer-readable storage medium (including one or more nonvolatile memory elements, such as EEPROM, EPROM, Flash memory, a hard drive, among other examples), that may store instructions and data for use by the IO control system 100. The memory 120 may be coupled to the processor 110, and may be configured to receive instructions 112 from the processor 110, and to exchange data 114 with the processor 110 (and one or more other modules of the IO control system 100). In some aspects, the memory 120 may include instruction random access memory (iRAM) 122 and data RAM (dRAM) 124. In some aspects, the memory 120, the iRAM 122, and the dRAM 124 may have a very small size, in order to maximize speed of operation and minimize the memory footprint of the IO control system 100. For example, in some aspects, the iRAM 122 may have a size of only 1 kB, and the dRAM 124 may have a size of only 256 B.

In some aspects, the addresses space for the IO control system 100 may be configured to have no more than 11 bits, that is, to have an address space no larger than 2048 addresses. When the processor 110 is a RISC-V processor, then this may enable more compact code and fewer instructions to be required for instructions issued by the processor 110. For example, in the RISC-V instruction set, when the immediate operand has no more than 11 bits, then a single instruction may address and write to each register of the IO control system 100. In some aspects this may enable the IO control system 100 to have a more compact code base and to require fewer instructions to reconfigure the GPIOs.

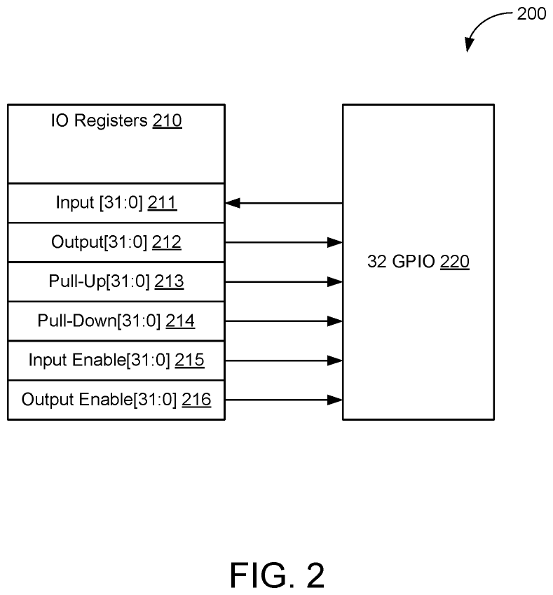

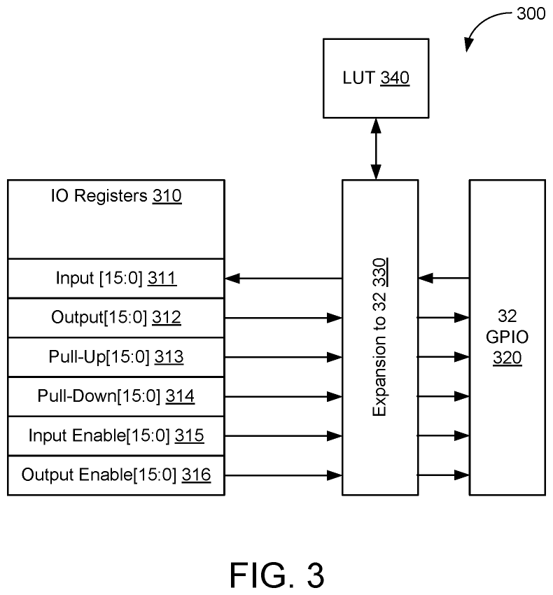

The IO registers 130 may include a plurality of control registers, where each control register is associated with a different configuration of the IO pins of the IO control system 100. For example, as discussed in more detail below with respect to FIGS. 2-3, one control register may configure GPIOs to act as inputs, while another control register may configure GPIOs to act as outputs, yet another control register may configure GPIOs to have a pull-down resistor, and so on. More particularly, each control register may include a plurality of bits, where each bit configures a corresponding GPIO to have the configuration associated with that control register. For example, setting bits of the input-related control register may configure corresponding GPIOs to act as inputs, setting bits of the pull-down control register may configure corresponding GPIOs to have a pull-down resistor, and so on. In some aspects, the IO control system 100 may have 32 GPIOs. The IO registers 130 may include multiple ways to control individual bits, including set-one-to-set and set-one-to-clear access methods that are provided on unique addresses.

The GPIO interface 140 may interface the GPIOs of the IO control system 100 with one or more external circuits, systems, or networks. For example, depending on the configuration associated with the IO registers 130, the GPIO interface 140 may couple the GPIOs of the IO control system 100 to one or more external circuits, systems, or networks which provide inputs to the IO control system 100, which may receive outputs or control signals from the IO control system 100, and so on.

The IO group configuration registers 150 may include a plurality of registers, each corresponding to an IO group. These IO groups may include a plurality of bits, with each bit corresponding to one of the GPIOs. As discussed in more detail below, the IO groups may enable the IO control system to address the IO control registers to enable reconfiguration of the GPIOs using the IO control registers in fewer clock cycles as compared with conventional techniques, and may enable such reconfiguration in a single clock cycle. In some implementations, certain GPIO settings (e.g., input enable, output enable, and pull-ups) may be provided in separate IO control registers, and an IO group configuration may allow for simultaneous control of all the GPIO settings and outputs for all of the pins in the IO group. For example, a block of 8 GPIO pins can have the output drivers disabled and pull-ups enabled on all the pins in one instruction. In some aspects, there may be 2, 4, or another suitable number of IO groups addressed using the IO group configuration registers 150. The IO group bits can be set in arbitrary bits to pick up individual GPIOs, while ignoring other pins. The IO groups may be used to isolate and sample just the desired IO pins. For example, setting an IO group configuration register to 0x5 would enable access to GPIO0 and GPIO2, while ignoring GPIO1. Furthermore the IO group settings may be used to compress the selected IO into a right-justified format. For example, with a group of 0x5, the access for {GPIO2, GPIO0} can be accessed as a 2-bit setting.

The timers 160 may include one or more timers configured to delay configuration of the GPIOs until a specified timer has elapsed. For example, each timer may have a duration of a specified multiple of clock cycles, such as 2, 4, 8, or another suitable number of clock cycles. In some aspects, the timers 160 may include two timers. In some aspects, each timer may correspond to a clock divider which may take as input a master clock signal of the IO control system 100 and reduce its frequency by the specified multiple. Such timers may be used for precise timing of read and write operations performed on the GPIOs of the IO control system 100. For example, a delay may be used before reading an input or an output signal until the signal has settled, and so on. The timers 160 may be driven by an internal clock of the IO control system 100 and/or by an external clock routed into the IO control system 100 through a GPIO pin. This can enable IO group actions that respond to externally provided clocks.

The bus interface 170 may be a suitable bus interface, such as an advanced high-performance (AHB) clock or another suitable bus interface configured to provide read or write access to the Memory 120, IO Registers 130, Timers 160, or I/O groups 150 to the IO control system 100. In some aspects, the bus interface clock may be a common clock signal used for embedded systems such as RISC-based systems, and may be used for driving the processor 110, in addition to the memory 120 and other registers of the IO control system 100. In some other aspects, the bus interface 170 may provide another suitable clock signal instead of the AHB clock signal. In some aspects, the bus interface 170 may provide a clock signal having a frequency of 200 MHz, while in some other aspects the clock signal may have another suitable frequency.

FIG. 2 shows an example block diagram 200 depicting one example of the IO registers 130 and the GPIO interface 140 of FIG. 1, in accordance with some implementations. As discussed above, the IO control system 100 may include 32 GPIOs. In some aspects, each IO register of the IO registers 130 may include 32 bits, with each bit corresponding to a GPIO of the IO control system 100. As discussed above, each IO register may correspond to a configuration of GPIOs, and so for example, the IO registers 210 may include an input register 211, an output register 212, a pull-up register 213, a pull-down register 214, an input enable register 215, and an output enable register 216. Each register of the IO registers 210 may include 32 bits, each bit corresponding to one of the GPIOs 220. Bits of the input register 211 correspond to GPIO pins of the GPIOs 220, and reading the bits of the input register 211 allows reception of data from the GPIOs 220 by the IO control system 100. Similarly, setting bits of the output register 212 allows alteration of the signals output from corresponding GPIO pins of the GPIO 220. Similarly, setting bits of the pull-up register 213 or the pull-down register 214 enable the configuration of the corresponding GPIO pins with a pull-up resistor or a pull-down resistor, respectively. Finally, the input enable register 215 and the output enable register 216 enable the configuration of the corresponding GPIO pins to act as an input (e.g., enabling reception of signals by the input register 211), or an output (e.g., enabling output of signals from the output register 212), respectively. In some aspects, the IO registers can include Schmitt trigger functionality enable pin that provides hysteresis on the input buffers, as well as test mode pins which can force the entire GPIO to be disabled. In alternative implementations, the pull-up and pull-down pins can be specified with a enable bit, and then a separate bit the selects either pull-up or pull-down functionality.

FIG. 3 shows an example block diagram 300 depicting another example of the IO registers 130 and the GPIO interface 140 of FIG. 1, in accordance with some implementations. Similarly to FIG. 2, the example of FIG. 3 includes IO registers 310, and 32 GPIOs 320. However, whereas in FIG. 2 each IO register includes 32 bits, in the example of FIG. 3, each IO register of the IO registers 310 includes only 16 bits. In addition, the block diagram 300 includes an expansion to 32 module 330 and one or more lookup tables (LUTs) 340. The IO registers 310 have similar functionality to the IO registers 210 of FIG. 2, and include an input register 311, an output register 312, a pull-up register 313, a pull-down register 314, an input enable register 315, and an output enable register 316. However, in the example of FIG. 3, the 32 GPIOs of the GPIOs 320 may be reordered into the 16 bits of the IO registers of the IO registers 310. For example, the expansion to 32 module 330 may translate the 16 bits of each of the IO registers 310 to corresponding GPIOs of the 32 GPIOs 320. In some aspects, the LUT 340 may indicate the bits of the IO registers 310 which correspond to the GPIOs of the 32 GPIOs 320. Enabling such reordering may enable calculations and data constructs within the IO control system 100 to be shorter and simpler, and thus execute more quickly and with a smaller codebase as compared to calculations involving 32 bits. In the case of the reordering from the expansion to 32 module 330, the 32 GPIO may have an additional sets of controls from another parallel set of 32-bit registers.

In some conventional IO control systems, bits of the IO registers, such as the IO registers 210 or the IO registers 310, may be altered using a read-modify-write technique, where the current status of a bit of one of the IO registers is read, and then written back with a changed value. In some other conventional IO control systems, a write 1 to set or a write 1 to clear technique may be used to set or clear the bits of the IO registers. However, in conventional systems, making multiple alterations to the configuration of the GPIOs takes multiple data accesses, multiple instructions, and thus multiple clock cycles. Aspects of the present disclosure enable such reconfigurations to be completed more quickly through the use of IO groups.

As discussed above, aspects of the present disclosure provide more efficient reconfiguration of GPIOs through the use of IO groups. Example implementations may use an IO group to apply changes to multiple IO registers, such as all of the IO registers 210 or the IO registers 310, based on the GPIOs indicated by the IO group. Further, such IO groups may be used in combination with one or more timers, such as the timers 160, enabling precise timing of the IO group based GPIO reconfigurations. Use of the IO groups may allow for modification of multiple specific bits of the IO registers 310 without requiring wasteful additional read or write operations on the specific bits or on remaining bits of the IO registers 310. For example, modifying only the desired bits of the IO registers as indicated by an IO group requires fewer operations as compared to conventional read-modify-write operations. These efficiencies may be further compounded when multiple IO registers require alteration for a given reconfiguration, such as two or more IO registers (e.g., when bits of the output IO register and the output enable IO register must both be altered).

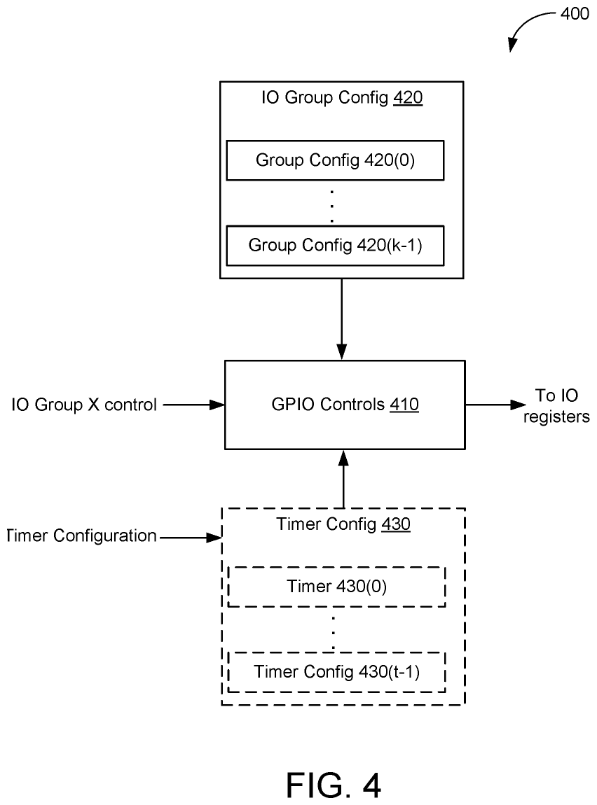

FIG. 4 shows an example flow chart 400 depicting an operation for configuring IO registers using IO groups, in accordance with some implementations. FIG. 4 shows GPIO controls 410 receiving instructions for IO register configuration for IO group X (“IO Group X control”). For example, such instructions may be received from a memory, such as the memory 120, or the iRAM 122 of the memory 120. The IO register configuration instructions for group X may indicate actions to be performed using an IO group control register, where bits of the IO group control register may indicate data bits for output using the GPIOs based on the IO group, and may also indicate configurations to be set in the IO registers based on the IO group. In some aspects, the IO group control register may include 26 bits, which may be structured as follows:

| Field | Bits | Description |
|---|---|---|
| Data | [15:0] | Sets the output bits (expanded to the IO group |
| | | locations) |
| Set IE | [16] | Sets all input enables of IO group |
| Clear IE | [17] | Clears input enables of IO group |
| Set OE | [18] | Sets output enables of IO group |
| Clear OE | [19] | Clears output enables of IO group |
| Set PU | [20] | Sets pull-up for IO group |
| Clear PU | [21] | Clears pull-up for IO group |
| Set PD | [22] | Sets pull-down for IO group |
| Clear PD | [23] | Clears pull-down for IO group |
| Open Drain | [24] | Enables open drain mode for IO group: |
| | | Logic 1: set OE off, enable pull-up |
| | | Logic 0: set OE on, set output to zero, disable |
| | | pull-up |
| Timer Select | [25] | Sets either timer 0 or timer 1 for WAIT gating |
| | | operations |

In the case of open drain operation, the GPIO pad can only drive a logic zero output by driving OV with an output enable set to 1, and the output value set to 0. In the case of a logic one output, the GPIO disables the output enable, and uses the pull-up to hold the logic high voltage. This protocol allows multiple drivers in the system to be connected together in a wired-AND configuration.

The contents of the IO register configuration instructions, such as indicated in the IO group control register, may indicate operations to be performed on a single IO register, or operations to be performed on multiple IO registers. An example where a single IO register may indicate the operations includes setting a pull-up resistor on one or more of the GPIOs. An example where multiple IO registers are to be changed is when the IO group control register takes the form indicated in the table above, indicating data to be output and setting output enable may indicate that the output register, such as the output register 312 and the output enable register, such as the output enable register 316 may concurrently be updated to include the indicated data, and to set output enable for the bits indicated by the IO group.

The GPIO controls 410 may also be coupled to the IO group configuration 420, which includes configuration details for k different IO groups. In some aspects, k may be 2 or 4, resulting in the IO group configuration 420 including details about 2 or 4 IO groups. For example, such information may be stored in a register associated with each of the IO groups, and may for example be stored in the IO group configuration registers 150 of FIG. 1. Each IO group configuration, such as the group configuration 420(0) through the group configuration 420(k−1) (collectively the IO group configurations 420) may include data indicating which bits of the IO registers are to be addressed by the corresponding IO group. For example, when bits 0 through 3 are to be addressed by IO group 0, then group configuration 420(0) may indicate that bits 0 through 3 are set to 1. In the example of FIG. 3, where the IO registers include 16 bits, this may result in the group configuration 420(0) including a hexadecimal value of 000F (or a binary value of 0000 0000 0000 1111).

In addition, the GPIO controls 410 may optionally be coupled to timer configuration 430, which may provide information about timers associated with the IO register configuration instructions, such as indicated by the timer select bit from the IO group control register. The timer configuration 430 may receive configuration instructions (“timer configuration”) indicating a configuration for one or more timers. The timer configuration 430 may include t timers, indicated in FIG. 4 as timers 430(0) through 430(t−1). In some aspects, t may be two. Each timer of the timer configuration 430 may indicate a number of clock cycles, such as a number of cycles of a clock signal associated with the bus interface 170 of FIG. 1. For example, timer 430(0) may be associated with a timer having a duration of 4 cycles of such a clock signal, while timer 430(1) may be associated with a timer having a duration of 8 such clock cycles. The GPIO controls 410 may also include first-in first-out (FIFO) functionality that enables multiple IO controls to be queued up at once and released by multiple triggers from the timers. The GPIO controls 410 may also sample input GPIO signals, and push into a FIFO block that collects multiple input GPIO signals.

In response to the IO register configuration instructions, the GPIO controls 410 may set bits of the IO registers based on the received instructions, the IO group configuration indicated by the instructions, and optionally based on a timer indicated by the instructions (e.g., one of the timers 430(0) through 430(t−1)).

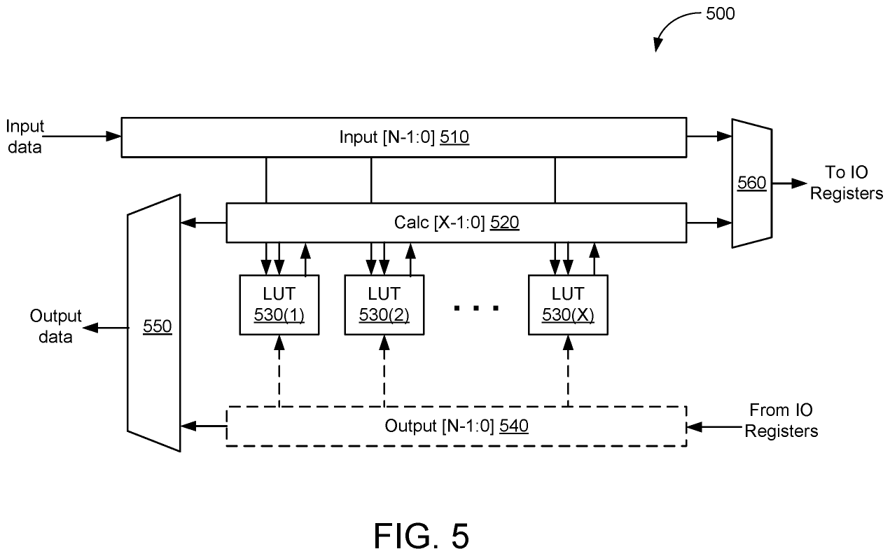

In addition to efficient reconfiguration of the IO registers based on IO groups, aspects of the present disclosure may provide for additional calculations to be performed on GPIO inputs and outputs. For example, FIG. 5 shows an example block diagram 500 indicating a circuit for performing calculations on IOs using look-up tables, in accordance with some implementations. FIG. 5 is shown to include an input register 510 having N bits, a calculation register 520 having X bits, a plurality of X look-up tables 530 (numbered LUT 530(1) through 530(X)), optionally an output register 540 having N bits, a first multiplexer (MUX) 550, and a second MUX 560.

The input register 510 receives input data. For example, the input register 510 may be included within or coupled to the IO registers 130 and may receive the input data from the GPIO interface 140 and provide the input data to the IO control system 100, such as by providing the input data to the IO registers 130. In some aspects, the input register 510 may have 16 bits, that is N may equal 16, while in some other aspects, N may equal 32. The input register 510 may provide the input data to the second MUX 560 and to one or more LUTs of the LUTs 530.

Similarly, the optional output register 540 receives data for output. For example, the output register 540 may be included within or coupled to the IO registers 130 and may receive data from the IO registers 130 for output via the GPIO interface 140. In some aspects, the output register 540 may have 16 bits. That is N may equal 16, while in some other aspects, N may equal 32. The output register 540 may provide the output data to the first MUX 550 and to one or more LUTs of the LUTs 530. In aspects where the output register 540 is not present, the output signals may be provided directly from the IO registers 130 to the first MUX 550. In some aspects, calculations using the calculation register 520 and the LUTs 530 may not be enabled when the output register 540 is not present.

The calculation register 520 may be configured to provide control signals to the LUTs 530, and to provide output signals from the LUTs 530 to the first MUX 550 and the second MUX 560. In some aspects, the calculation register 520 may include X bits, one for each LUT of the LUTs 530. In some aspects, X may be 7, meaning that the calculation register 520 may have 7 bits, and that there may be 7 LUTs 530. The first MUX 550 can enable a straight loopback on input data, through the LUTs 530 and output on pins. The second MUX 560 may be used to replace inputs, or enable additional inputs signals derived from the input data. An example may be an additional parity bit on the input data (e.g., expanding from 8-bits to 9-bits) for the second MUX 560. An example with respect to the first MUX 550 may be to provide an AND of two input signals and driving an output.

The LUTs 530 may include X lookup tables, each having either 3 or 4 inputs. The LUTs 530 may each have 3 inputs when the output register 540 is not present, and may each have 4 inputs when the output register 540 is present. The LUTs 530 may enable for logic operations to be performed on input data and output data, for example, logical AND, OR, XOR, and XNOR operations may be enabled using the calculation register 520 and the LUTs 530. In some aspects, the calculation register 520 and the LUTs 530 may be configured using instructions received from the memory 120, such as the iRAM 122. In some aspects, in order to prevent loopback issues, each LUT of the LUTs 530 may only be fed from previous LUTs in the chain of LUTs. For example, LUT 530(n) may only be fed from LUTs 530(1) through 530(n−1).

The first MUX 550 and the second MUX 560 may enable calculations performed using the calculation register 520 and the LUTs 530 to selectively replace outputs from and inputs to the IO control system 100. For example, instructions received from the memory 120, such as the iRAM 122, may be used for configuring the first MUX 550 and the second MUX 560.

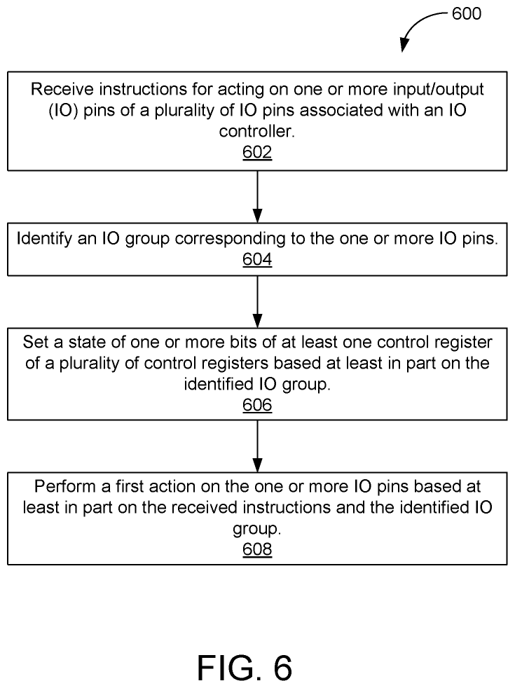

FIG. 6 shows an illustrative flow chart depicting an example operation 600 for configuring IO signals, according to some implementations. In some aspects, the operation 600 may be performed by a suitable IO control system, such as the IO control system 100 of FIG. 1.

At block 602, the IO control system 100 received instructions for acting on one or more IO pins of a plurality of IO pins associated with an IO controller.

At block 604, the IO control system 100 identifies an IO group corresponding to the one or more IO pins.

At block 606, the IO control system 100 sets a state of one or more bits of at least one control register of a plurality of control registers based at least in part on the identified IO group.

At block 608, the IO control system performs a first action on the one or more IO pins based at least in part on the received instructions and the identified IO group.

In some aspects, each control register of the plurality of control registers is configured to set a corresponding configuration of the plurality of IO pins. In some aspects, the corresponding configuration includes configuring the IO pins for receiving an input signal or for providing an output signal via IO pins of the plurality of IO pins. In some aspects, the corresponding configuration includes configuring the IO pins for applying a pull-up resistor or a pull-down resistor to IO pins of the plurality of IO pins. In some aspects, the corresponding configuration includes configuring the IO pins for applying an input enable or applying an output enable to IO pins of the plurality of IO pins.

In some aspects, setting the state of one or more bits of at least one control register in block 606 includes setting the state of one or more bits of two or more control registers of the plurality of control registers. In some aspects, setting the state of one or more bits of at the two or more control registers further includes configuring the one or more IO pins to receive at least a first configuration corresponding to a first control register of the plurality of control registers and a second configuration different from the first configuration corresponding to a second control register of the plurality of control registers.

In some aspects, the operation 600 further includes identifying a first timer associated with the received instructions, wherein the first action is performed in response to the first timer. In some aspects, the first timer corresponds to a specified number of clock cycles associated with a clock signal for the IO controller. In some aspects, the clock signal originates externally to the IO controller.

In some aspects, the plurality of IO pins includes a plurality of general purpose IO (GPIO) pins. In some aspects, the plurality of GPIO pins include 32 GPSIO pins, wherein each control register of the plurality of control registers includes 32 bits. In some aspects, the plurality of GPIO pins includes 32 pins, wherein each control register of the plurality of control registers includes 16 bits. In some aspects, the operation 600 further includes reordering the one or more IO pins after performing the first action.

In some aspects, performing the first action on the one or more IO pins in block 608 includes performing one or more logic operations via one or more look-up tables.

In some aspects, the operation 600 further includes queuing a plurality of actions in a first-in-first-out (FIFO) order based on the received instructions, the first action included in the plurality of actions, and performing the plurality of actions on the one or more IO pins in the FIFO order.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method performed by an input/output (IO) controller for configuring IO signals, comprising:
receiving instructions for acting on one or more IO pins of a plurality of IO pins associated with the IO controller;
identifying an IO group corresponding to the one or more IO pins;
setting a state of one or more bits of at least one control register of a plurality of control registers based at least in part on the identified IO group; and
performing a first action on the one or more IO pins based at least in part on the received instructions and the identified IO group.

2. The method of claim 1, wherein each control register of the plurality of control registers is configured to set a corresponding configuration of the plurality of IO pins.

3. The method of claim 2, wherein the corresponding configuration comprises configuring the IO pins for receiving an input signal or for providing an output signal via IO pins of the plurality of IO pins.

4. The method of claim 2, wherein the corresponding configuration comprises configuring the IO pins for applying a pull-up resistor or applying a pull-down resistor to IO pins of the plurality of IO pins.

5. The method of claim 2, wherein the corresponding configuration comprises configuring the IO pins for applying an input enable or applying an output enable to IO pins of the plurality of IO pins.

6. The method of claim 2, wherein the at least one control register comprises two or more control registers.

7. The method of claim 6, wherein setting the state of one or more bits of two or more control registers based at least in part on the identified IO group further comprises configuring the one or more IO pins to receive at least a first configuration corresponding to a first control register of the plurality of control registers and a second configuration different from the first configuration corresponding to a second control register of the plurality of control registers.

8. The method of claim 1, further comprising:
identifying a first timer associated with the received instructions, wherein the first action is performed in response to the first timer.

9. The method of claim 8, wherein the first timer corresponds to a specified number of clock cycles associated with a clock signal for the IO controller.

10. The method of claim 9, wherein the clock signal originates externally to the IO controller.

11. The method of claim 1, wherein the plurality of IO pins comprises a plurality of general purpose input/output (GPIO) pins.

12. The method of claim 11, further comprising reordering the one or more IO pins after performing the first action.

13. The method of claim 1, wherein performing the first action on the one or more IO pins comprises performing one or more logic operations via one or more look-up tables.

14. The method of claim 1, further comprising:
queuing a plurality of actions in a first-in-first-out (FIFO) order based on the received instructions, the first action included in the plurality of actions; and
performing the plurality of actions on the one or more IO pins in the FIFO order.

15. A control circuit for an input/output (IO) block, comprising:
a plurality of IO pins coupled to the IO block;
a plurality of control registers coupled to the IO pins;
a plurality of IO group registers;
one or more processors; and
a memory storing instructions for execution by the one or more processors, wherein execution of the instructions causes the control circuit to perform operations comprising:
receiving instructions for acting on one or more IO pins of the plurality of IO pins;
identifying an input/output group (IO group) corresponding to the one or more IO pins, the IO group corresponding to an IO group register of the plurality of IO group registers;
setting a state of one or more bits of at least one control register of the plurality of control registers based at least in part on the identified IO group; and
performing a first action on the one or more IO pins based at least in part on the received instructions and the identified IO group.

16. The control circuit of claim 15, wherein each control register of the plurality of control registers is configured to set a corresponding configuration of the plurality of IO pins.

17. The control circuit of claim 16, wherein the corresponding configuration comprises configuring the IO pins for receiving an input signal or for providing an output signal via IO pins of the plurality of IO pins.

18. The control circuit of claim 16, wherein setting the state of one or more bits of at least one control register based at least in part on the identified IO group further comprises configuring the one or more IO pins to receive at least a first configuration corresponding to a first control register of the plurality of control registers and a second configuration different from the first configuration corresponding to a second control register of the plurality of control registers.

19. The control circuit of claim 15, wherein execution of the instructions causes the control circuit to perform operations further comprising:
identifying a first timer associated with the received instructions, wherein the first action is performed in response to the first timer.

20. The control circuit of claim 15, wherein the plurality of IO pins comprises a plurality of general purpose input/output (GPIO) pins.
